(19) United States
(12) Patent Application Publication
(10) Pub. No.: US 2005/0253825 A1
(43) Pub. Date: Nov. 17, 2005

(54) Video display apparatus

(75) Inventors: Tomoyuki Kawamura, Yokohama (JP); Shuichi Yano, Yokohama (JP); Hidenao Kubota, Yokohama (JP); Haruki Takata, Yokohama (JP)

Correspondence Address: MCDERMOTT WILL & EMERY LLP, 600 13th Street, N.W., Washington, DC, 20005-3096, US

(73) Assignee: HITACHI, LTD.

(21) Appl. No.: 10/963,782

(22) Filed: Oct. 14, 2004

(30) Foreign Application Priority Data
May 11, 2004 (JP) 2004-140556

(51) Int. Cl. G09G 5/00

(52) U.S. Cl. 345/204

(57) ABSTRACT

A video display apparatus includes a brightness modulating circuit that reduces the image brightness of the peripheral area of a display panel as compared to that of the central area of the display panel, and a control circuit that controls the operation of the brightness modulating circuit on the basis of the power consumption of the display panel in which the control circuit controls the brightness modulating circuit to be active when the power consumption of the display panel exceeds a predetermined threshold, and stops the operation of the brightness modulating circuit when it is smaller than the predetermined threshold.

### INCORPORATION BY REFERENCE

The present application claims priority from Japanese application JP 2004-140556 filed on May 11, 2004, the content of which is hereby incorporated by reference into this application.

### BACKGROUND OF THE INVENTION

The present invention generally relates to a video display apparatus having a display panel, and particularly to a video display apparatus suited to suppress the power consumption from increasing and to obtain bright images in the display panel of self-luminous type like a plasma display panel (hereinafter, abbreviated PDP).

The PDP has a low contrast (bright-room contrast) in a daytime-bright living room since its all-white brightness is low as compared with a display device using CRT and LCD. The number of discharge pulses and the pulse voltages can be raised in order to intensify the display brightness, but in that case, there arises problem of increasing power consumption.

There have been proposed related techniques such as JP-A-6-282241 and JP-A-2002-55675 to solve this problem of the PDP or to restrict the power consumption but to improve the image brightness. As described in these documents, circuits are provided to reduce the brightness of the peripheral area of the image as compared with that of the central area of the image (hereinafter, such circuits are called “brightness modulating circuit”), and the power corresponding to that reduction of the brightness is, instead, used additionally for the brightness of the central area to be increased, so that the apparent brightness of the image can be improved with the power consumption being suppressed.

In such related techniques as described in JP-A-6-282241 and JP-A-2002-55675, the human visual sense characteristic is used of the fact that the human eyes do not easily perceive the reduction of the brightness of the peripheral area of the bright image that has a high luminance level. This visual sense characteristic is caused by the fact that the human visual sense has the so-called logarithmic characteristic to the brightness. In other words, the related techniques described in JP-A-6-282241 and JP-A-2002-55675 employ the brightness modulating circuit mentioned above so that, when a bright image is displayed, the apparent brightness of the displayed image can be improved without much of visual uncomfortable feeling and with the power consumption suppressed.

In the documents of JP-A-6-282241 and JP-A-2002-55675, however, the above brightness modulating circuit is always operated independently of when the displayed image is bright and dark. Therefore, even when the displayed image is totally low in brightness, a brightness difference occurs between the central and peripheral areas of the image. Since the human visual sense has the so-called logarithmic characteristic to the brightness as mentioned above, the human eyes do not visually perceive the above brightness difference with ease when a bright image is displayed, but easily perceive the difference when a dark image is displayed. Thus, there is fear that, when the above brightness modulating circuit is operated while a dark image is being displayed, the brightness difference appears as a brightness irregularity to reduce the quality of the displayed image.

In addition, when a dark image is displayed, or when the average picture level (hereinafter, abbreviated “APL”) of the input video signal is low, an automatic power control circuit (hereinafter, abbreviated “APC circuit”) is not operated that limits the load on, or output brightness of the display panel to a constant value because the load on the display panel is low. In other words, the low APL region has a proportionality relation between APL value and output brightness. Therefore, darkening the peripheral area of the dark image results in the reduction of the quality of the displayed image in that the video signal should be reproduced faithfully.

Moreover, even when the above brightness difference is provided in a dark image, there is no effect or little effect of improving the apparent brightness, and the dark image could be rather viewed as a further darkened image.

### SUMMARY OF THE INVENTION

In view of the above aspect, it is an objective of the invention to provide a video display apparatus capable of suppressing the power consumption from increasing and of displaying a high-definition image.

In order to achieve the above objective, according to the invention there is provided a video display apparatus that has a control circuit to control the brightness modulating circuit in accordance with the amount of an operating status to or of a display panel such as PDP.

Specifically, as an example of the above amount of the operating status, the average power level of the input video signal is detected, and judgment is made of whether this detected average power level exceeds a predetermined threshold. If this average power level exceeds the predetermined threshold, the brightness modulating circuit is made active. If this average brightness level is smaller than this threshold, the brightness modulating circuit is made inactive.

In addition, as another example of the above amount of the operating status, the power consumption of the display panel is detected, and judgment is made of whether this detected power consumption exceeds a predetermined threshold. If the detected power consumption exceeds the predetermined threshold, the brightness modulating circuit is made active. If the detected power consumption is smaller than this threshold, the brightness modulating circuit is made inactive.

Furthermore, in a load region (high APL region) where an automatic output control circuit for limiting the power consumption of the display panel to a predetermined value or below is operated, the brightness modulating circuit is actuated. In another load region (low APL region) in which the automatic output control circuit is not operated, the brightness modulating circuit is made inactive.

The brightness modulating circuit may be constructed to modulate the input video signal by linearly or nonlinearly reducing the brightness of the image displayed on the display panel more as the process proceeds from the central area of the image to the peripheral area of the image. As a method for nonlinearly reducing the brightness, the range from the central area to peripheral area of the image may be divided into a region ranging from the center of the image to a predetermined point between the center and edge of the image, where the brightness is reduced at a first reduction rate, and the other region ranging from the predetermined point to the edge of the image, where the brightness is reduced at a second reduction rate different from the first reduction rate.

According to the invention, high-definition images can be displayed with the power consumption suppressed. Specifically, in the high APL (high load) region, the brightness of the central area of the image can be increased with the power consumption kept constant so that high-definition images can be displayed with a high bright-room contrast. In the low APL (low load) region, the quality of images can be prevented from be deteriorated since no brightness difference is caused between the central area and peripheral area of the image.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing the process in the first embodiment of the invention.

FIGS. 2A and 2B are diagrams useful for explaining the operation characteristics of the APC function.

FIG. 3 is a block diagram of a PDP type display apparatus showing the first embodiment of the invention.

FIGS. 4A, 4B and 4C are diagrams useful for explaining shading gain α as brightness correction data.

FIGS. 5A and 5B are graphs showing the relation between the APL of input signal and the brightness of displayed image in the first embodiment.

FIGS. 6A and 6B are graphs of the shading gain α in the first and second embodiments.

FIGS. 7A and 7B are graphs showing the relation between the APL of input signal and the brightness of displayed image in the second embodiment.

FIG. 8 is a flowchart showing the process in the third embodiment of the invention.

FIG. 9 is a block diagram of a PDP type display apparatus showing the third embodiment of the invention.

FIGS. 10A and 10B are graphs showing the shading gain a in the third embodiment.

### DETAILED DESCRIPTION OF THE EMBODIMENTS

Preferred embodiments of the invention will be described with reference to the drawings. In each figure, like elements having the same function are designated by the same reference numerals, and will not be repeatedly described for the sake of simplicity.

Although a PDP type display apparatus is given below as an example of the video display apparatus, the present invention is not limited to this apparatus, but can also be applied to an video display apparatus using a display panel of the self-luminous type in which the power consumption increases substantially in proportion to the display load, for example, an LED panel having elements of FED (Field Emission Display), EL or LED arranged in a matrix configuration.

The present invention is characterized in that the video display apparatus using a self-luminous type display panel controls the brightness-modulation processing operation, which reduces the brightness of the peripheral area of the image in accordance with the power consumption of the display panel. In the description given below, the “peripheral area” is defined as an area of 0.5 or above distance from the center (that is, a range between relative distances of 0.5 to 1.0) when the distance from the center of the display panel surface to the horizontal or vertical outer edge of the display surface is relative distance 1.0. Thus, when “the brightness of the peripheral area is reduced as compared to the central area”, this means that the brightness of any pixels included within the range of relative distance 0.5 to 1.0 in the relative distance is at least lower than those located in the central area. The central area is defined as an area of relative distances 0 to 0.5. In addition, APL is defined as the average power level per frame or field of the video signal.

### EMBODIMENT 1

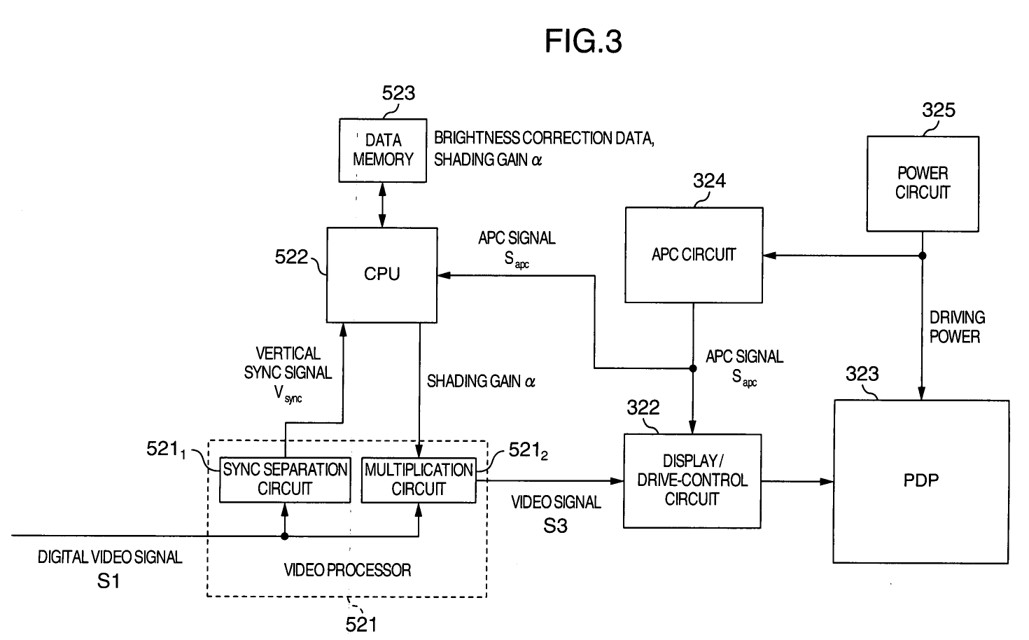

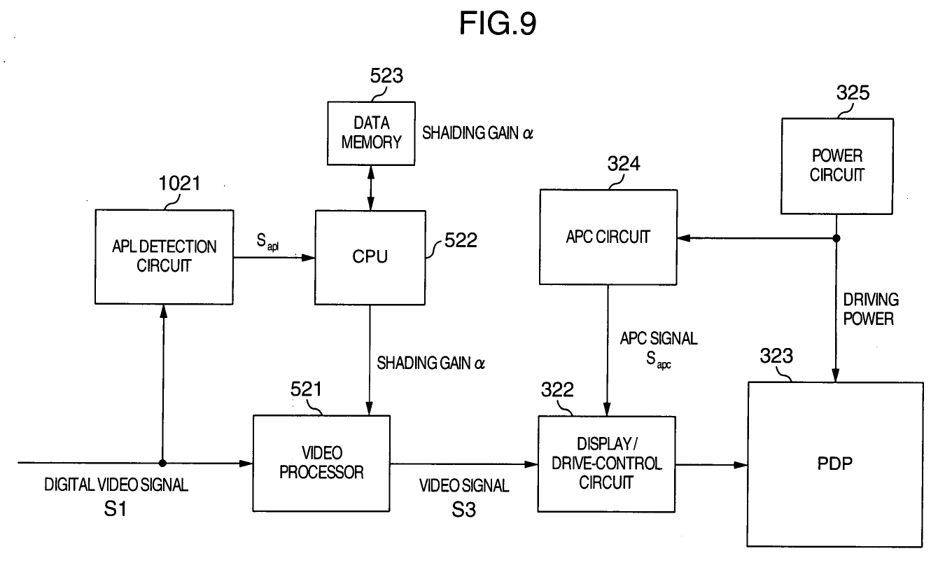

FIG. 3 is a block diagram of a PDP type display apparatus showing an embodiment of the invention. Referring to FIG. 3, there is shown a video processor 521 that includes a brightness modulating circuit for making the brightness modulating process to lower the brightness of the peripheral area of the image (hereinafter, sometimes called “peripheral-area brightness-reducing process”). This brightness modulating circuit 521 is formed of a sync separation circuit 521₁ and a multiplication circuit 521₂ as, for example, shown in FIG. 3. A system controller (hereinafter, called “CPU”) 522 is used to control the video signal to be processed, and it is formed of a microcomputer or the like. A data memory 523 is used to store brightness correction data (which will be described later). The video processor 521 has a function to supply the timing of the received signal to the CPU 522 in addition to the peripheral-area brightness-reducing process. In this embodiment, the video processor 521 has the sync separation circuit 521₁ that separates the vertical sync signal V_{sync} from the received video signal and supplies it to the CPU 522. A display/drive-control circuit 322, a PDP 323, an automatic power control circuit (hereinafter, called APC circuit) 324, and a power circuit 325 as shown in FIG. 3 are the circuits and display panel having the same functions as those in FIG. 9. However, in this embodiment, the APC signal S_{apc} fed from the APC circuit 324 in response to the power consumption of PDP 323 is also supplied to the CPU 522.

The outline of the automatic power control function (hereinafter, called APC function) of APC circuit 324 will be described. The APC circuit, when the electric load required to display (hereinafter, called “display load”) increases, controls (limits) the drive current or drive voltage to the PDP to a predetermined value, thus preventing the power consumption of the PDP from being more than necessary. This PDP type display apparatus has the same function as above with almost no exceptions. The APC circuit 324 in this embodiment monitors the power that is supplied from the power circuit 325 to the PDP. For example, it detects the current fed from the power circuit 325 to the PDP 323. An integration circuit not shown converts this detected current to the average voltage value of the consumption current, and supplies it as the APC signal S_{apc} to the display/drive-control circuit 322. The display/drive-control circuit 322 drives the PDP 323 on the basis of this APC signal S_{apc}, for example, by increasing or decreasing the number of pulses for discharge to be maintained, thus controlling the power so that the power consumption can be prevented from being more than a predetermined level. This APC function is known from, for example, Japanese Patent No. 3298926, and thus will not be described in detail.

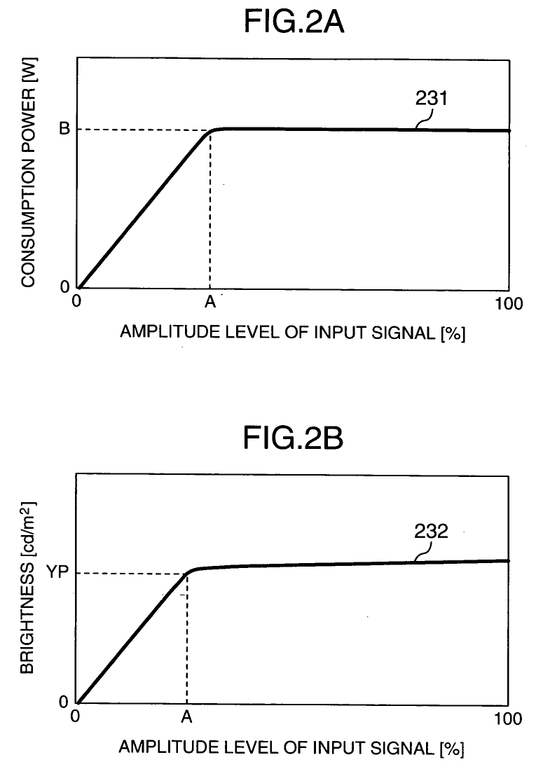

The operating characteristic of this APC circuit is shown in FIG. 2A by a characteristic 231. This characteristic is an input video signal amplitude level vs. power consumption characteristic in the case where a video signal is supplied to display white on all screen of a general PDP type display apparatus (hereinafter, this displaying is called “all white”). A characteristic 232 shown in FIG. 2B is an input video signal amplitude level vs. brightness characteristic in the case where the same video signal as above is supplied. The power consumption shown in FIG. 2A is the power necessary for the PDP to emit light. The PDP increases the display load with the increase of the area of the displayed image and the amplitude level of the input signal and thus increases the power consumption as the operation is understood from its emission principle. In other words, as illustrated in FIG. 2A, when the amplitude level of the input signal is in the range below level A, the power consumption is linearly (sometimes, nonlinearly) increased with the increase of the amplitude level of the input signal. When the amplitude level of the video signal exceeds the level A, the APC function becomes active to limit the power consumption to a certain level B.

The result of this control action affects the displayed image, particularly the brightness by the all-white signal. That is, when the video signal is supplied to be displayed over all the screen, the brightness is increased substantially linearly (sometimes, nonlinearly) with the increase of the amplitude level of the input video signal until the amplitude level of the input video signal reaches a certain value A, but it is acted by the APC function when the amplitude level exceeds the level A as shown in FIG. 2B by the characteristic 232. As a result, the power consumption is controlled to fix to a certain value, and the brightness is also limited to a certain brightness level according to the power consumption (hereinafter, this brightness level is referred to as “YP”).

The operation of the PDP type display apparatus shown in FIG. 3 will be described next. The video processor 521 does not make a special process on the first frame of the input video signal, and thus a video signal S3 is equal to a video signal S1 as shown. In addition, the APC circuit 324 monitors the power necessary for the video signal to be displayed at this time, and supplies the APC signal S_{apc} as this detected value to the display/drive-control circuit 322 and also to the CPU 522.

When the second frame and the following frames of the video signal are supplied, the CPU 522 reads out the shading gain α as the brightness correction data, which was previously stored within the data memory 523, on the basis of the APC signal S_{apc} supplied from the APC circuit 324, and supplies it to the video processor 521.

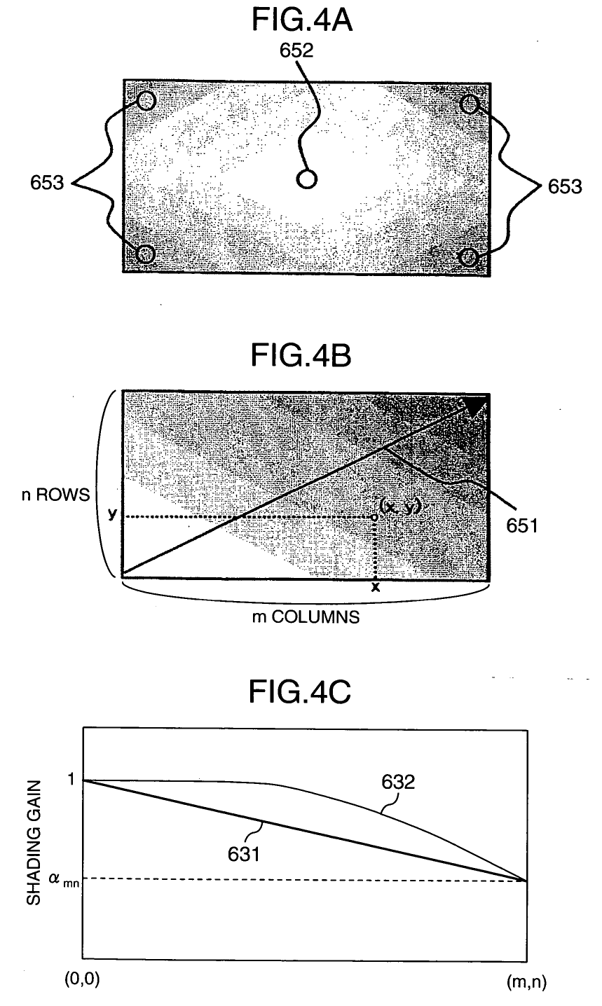

Here, the shading gain α means a weighting factor of brightness change in each pixel that is used for the brightness modulating process to be made in this invention. The shading gain α for each pixel is reduced the more as the pixel to be excited on the screen is shifted to be more distant away from the center of the image so that the peripheral-area brightness-reducing process can be made (the characteristic of shading gain α will be described later with reference to FIG. 4).

In the video processor 521, the multiplication circuit 521₂ multiplies the brightness data of each pixel by the shading gain α, and supplies the produced video signal S3 to the display/drive-control circuit 322 so that a video image based on this signal is displayed on the PDP 323.

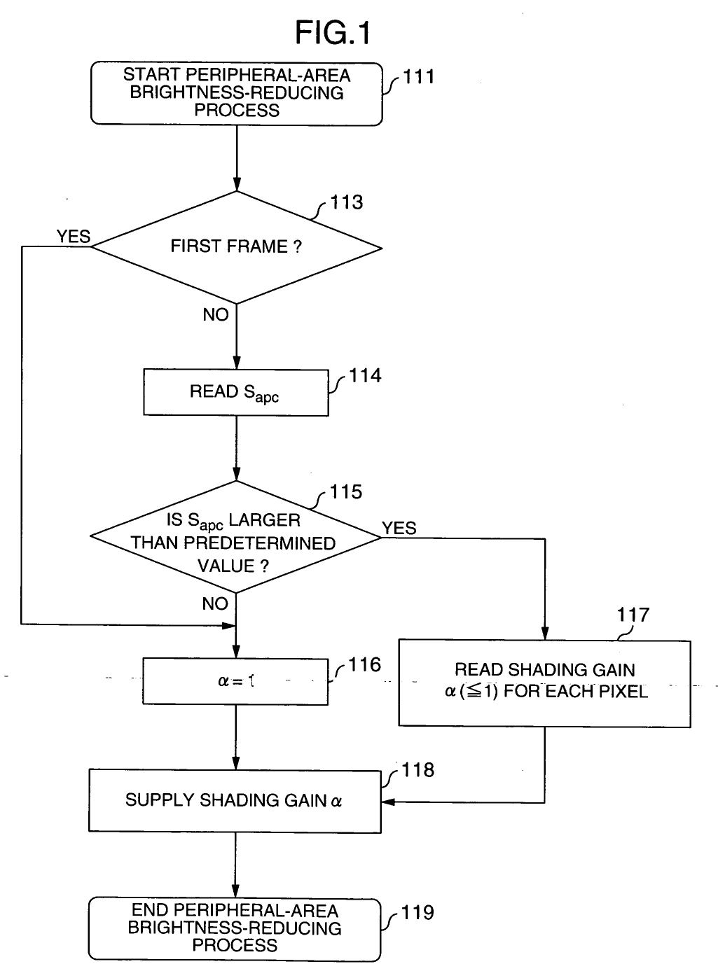

FIG. 1 is a flowchart showing the procedure of the process that the CPU 522 makes. Referring to FIG. 1, when a video signal is fed to the video processor 521, the sync separation circuit 521, separates the vertical sync signal V_{sync} from the video signal and supplies it to the CPU 522. The CPU 522 starts the peripheral-area brightness-reducing process immediately after the sync signal V_{sync} is fed (step 111). First, in step 113, judgment is made of what order of frame the current video signal to be processed is on the basis of this V_{sync}. If the received video signal is the first frame, the process goes to step 116, where the shading gain α is fixed to 1. In step 118, this shading gain α=1 is supplied to the video processor 521. In the video processor 521, the multiplication circuit 521₂ multiplies the brightness level of the video signal S1 by this shading gain α to produce the video signal S3. Therefore, when the current video signal is the first frame, the video signal S3 is equal to the video signal S1. The video signal S3 is supplied to the display/drive-control circuit 322. The display/drive-control circuit 322 drives the PDP 323 to display the video signal on the basis of the video signal S3. At this time, the APC circuit 324 detects the driving power necessary for the video signal to be displayed, so that the APC signal S_{apc} indicative of this driving power can always be supplied to the display/drive-control circuit 322 and CPU 522. The CPU 522, after the end of step 118, finishes the peripheral-area brightness-reducing process in step 119, and waits for the V_{sync} of the next frame to be fed.

If the input video signal is the second frame or the following frames, the APC signal S_{apc} produced from the APC circuit 324 during the period of displaying the video signal of the previous frame is read out in step 114. Then, in step 115, judgment is made of whether the APC function is operated. In other words, if the APC signal S_{apc} is larger than a certain threshold at which a predetermined APC function becomes active (hereinafter, simply called the threshold), the APC function is actuated. In step 117, the shading gain α for each pixel is read out from the data memory 523. In step 118, this shading gain α is supplied to the video processor 521. The video processor 521 generates the video signal S3 by the same process as on the first frame. However, since the shading gain α is changed to be smaller as the current pixel to be excited one after another proceeds to be more distant away from the center of the image, the video signal S3 at this time, or in the peripheral area has a lower brightness level than the video signal S1. If the APC signal S_{apc} is lower than the threshold in step 115, the APC function is not operated. Then, in step 116, the shading gain α=1 is selected as in the first frame of the video signal, and supplied to the video processor 521 (step 118). This process mentioned above is performed for each frame of the received video signal.

While the shading gain α is controlled on the basis of the driving power supplied during the period of displaying the previous frame in this embodiment, this period is not necessary to be the frame unit, but may be any duration unless it unnaturally affects the video signal to be displayed.

Thus, in this embodiment, the brightness slope forming means provided in the video processor 521 in order to reduce the brightness of the peripheral area of the image is controlled in its operation in accordance with the APC signal S_{apc} corresponding to the power consumption of the display panel. In addition, when the APC signal S_{apc} is lower than the threshold where the APC function is operated, the peripheral-area brightness-reducing process is not performed, but when it is larger than the threshold, the peripheral-area brightness-reducing process is carried out.

The method for the brightness modulating process (steps 117 and 118) according to this embodiment will be described in detail with reference to FIGS. 4A, 4B and 4C. This process is performed when the APC signal S_{apc} is larger than the threshold as described with reference to the above flowchart (FIG. 1).

In the data memory 523 is previously stored the brightness correction data that is used to correct the power level of the digital video signal S1 fed to the video processor 521. This brightness correction data in this embodiment is the shading gain α (≦1) by which the power level of the digital video signal S1 is multiplied. In the video processor 521, the multiplication circuit 521₂ multiplies the power level of the inputted digital video signal S1 by the shading gain α fed from the CPU 522 to produce the corrected video signal S3.

FIGS. 4A, 4B and 4C are diagrams useful for explaining the shading gain α as the brightness correction data previously stored in the data memory 523. FIG. 4A shows an image of the brightness over the entire display screen after the shading process, and FIG. 4B is a magnified view of the upper right corner of the image shown in FIG. 4A. The area shown in FIG. 4B is composed of horizontal m columns and vertical n rows of pixels, or a total of m×n pixels.

FIG. 4C shows the change of the shading gain α in the arrow-651 direction shown in FIG. 4B. In FIG. 4C, the shading gain α₀₀ of the pixel (0, 0) at the center of the image is 1, and the shading gain αₘₙ of the pixel (m, n) of the image is smaller than or equal to 1 (≦1). The brightness slope between the pixels (0, 0) and (m, n) is smoothly, for example, linearly changed as indicated by, for example, a characteristic line 631. In this case, the shading gain α_{xy} of an arbitrary pixel (x, y) within the area shown in FIG. 4B can be calculated from the following expression (1).

$${α}_{xy} = 1 - \frac{1 - {α}_{mn}}{\sqrt{{m}^{2} + {n}^{2}}} \times \sqrt{{x}^{2} + {y}^{2}} \qquad ( 1 )$$

Thus, in the data memory 523 is stored the shading gain α that has the brightness correction data that increases the reduction rate of the power level as the pixel to be excited is shifted more away from the center toward the periphery of the image. Accordingly, the power level is reduced continuously as the pixel to be excited is shifted to go away from the center toward the periphery of the image. Therefore, no one feels odd about the image displayed by the above construction.

While the power level is linearly lowered toward the periphery of the image from the center as indicated by the characteristic line 631 in FIG. 4C in this embodiment, the actually used shading gain α may be linearly changed as indicated by a characteristic curve 632. Use of the shading gain having the characteristic curve 632 will result in the appearance of the power-level uncorrected region in the central area of the image. Also in this case, the expression for the calculation of α_{xy} is different from the expression (1). The shading gain for this nonlinear brightness modulating process is composed of two portions. The first portion makes the brightness modulation with a first slope over the range from the central area to a predetermined point (ma, na) located between the center (0, 0) and outer edge (m, n) of the image. The power level reduction rate of this portion may be 0. The second portion makes the brightness modulation with a larger second slope than the first slope over the range from the point (ma, na) to the outer edge (m, n) of the image. In other words, the reduction rate of power level in the second portion is made larger than that in the first portion. Thus, the visual brightness can be effectively improved. The above predetermine point (ma, na) may be located at a position corresponding to the vertical relative distance 0.5 and horizontal relative distance 0.5.

The video image of which the power level is smoothly (continuously) lowered toward the peripheral area from the center of the image does not make humans feel uncomfortable through the eyes. This fact can be understood from an example of the current flat CRT display. In other words, the PDP can display images with uniform brightness over the entire screen, while the flat CRT display has peripheral brightness of as low as 40% to 60% to that of the central area. This low brightness characteristic is caused by the structure of the flat CRT display, but one can watch the displayed image without uncomfortable feeling through the eyes. Therefore, it can be understood that even if the PDP type display apparatus is designed to gradually lower the brightness toward the periphery like the flat CRT display, it does not make the humans feel uncomfortable through the eyes.

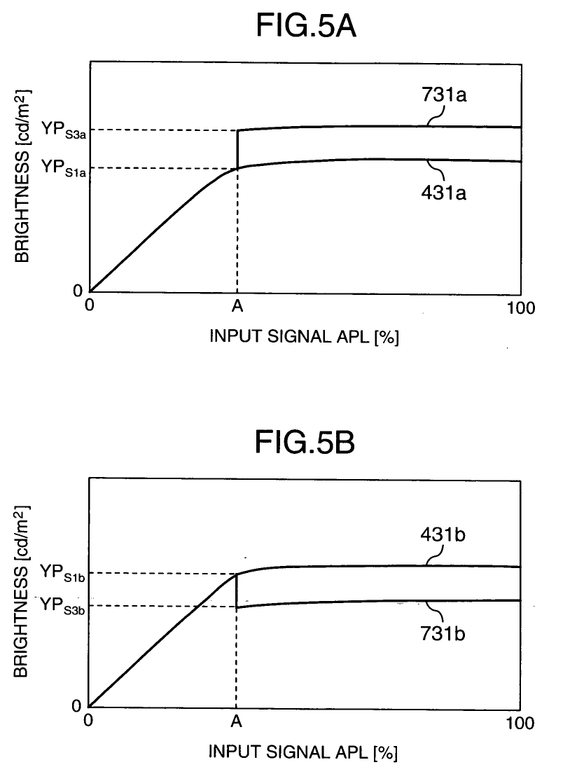

A description will be made of the image displayed on the PDP type display apparatus having the APC function as in this embodiment when the video signal S3 with the periphery power level lowered (the center power level is not lowered in this embodiment) is supplied as described above. FIG. 5A shows the inputted video signal APL-brightness characteristic of the central area of the image indicated by the region 652 in FIG. 4A. FIG. 5B shows the inputted video signal APL-brightness characteristic of the peripheral area of the image indicated by the region 653 in FIG. 4A. In FIGS. 5A and 5B, subscript a is attached to the brightness of the central area of the image, and subscript b to the brightness of the peripheral area of the image. In addition, A represents the APL of the video signal S3 that causes the APC function to be active and that is fed from the video processor 521 to the display/drive-control circuit 322. The characteristic curves 431a, 431b are the curves given in the prior art, and the characteristic curves 731a, 731b are the curves according to this embodiment.

Referring to FIGS. 5A and 5B, when the APL of the video signal S3 fed from the video processor 521 to the display/drive-control circuit 322 is lower than A, or when the APC signal S_{apc} is lower than the threshold, the video processor 521 does not make the peripheral-area brightness-reducing process, so that the characteristics of the peripheral area and central area, 731a, 731b are the same as the characteristics 431a, 431b. In other words, there is no brightness difference between the peripheral area and the central area, and thus the quality of the displayed image in the low-APL region about which difficulties were left in the prior art is not deteriorated.

Conversely, when the APL level of video signal S3 is larger than A, or when the APC signal S_{apc} is larger than the threshold, the video processor 521 makes the peripheral-area brightness-reducing process as in steps 117, 118 in FIG. 1. Therefore, the brightness of the peripheral area of the image is lowered to satisfy YP_{S3b}<YP_{S1b} as indicated by the characteristic curves 731b, 431b in FIG. 5B.

In the related techniques, when the APC function was actuated, the display/drive-control circuit 322 reduced, for example, the number of discharge-maintaining pulses to limit the brightness to YP_{S1a}, YP_{S1a}. In this embodiment, however, when the video processor 521 makes the peripheral-area brightness-reducing process, the power consumption is cut down due to the reduction of the peripheral-area brightness. In addition, since the brightness of the central area of the image can be raised additionally by the amount corresponding to the power reduction due to the lowering of the peripheral-area brightness, the level of the limiter in the display/drive-control circuit 322 can be raised (that is, for example, the number of discharge-maintaining pulses can be increased) with the power consumption kept constant. Therefore, the brightness in the central region 652 is raised to satisfy YP_{S3a}>YP_{S1a} as indicated by the characteristic curves 731a, 431a. Thus, the bright-room contrast can be improved.

In other words, when the input video signal is strong enough to make the APC function active, or when the video signals S1 and S3 are supplied, the brightness of the central area of the image of video signal S3 is higher, thus making the bright-room contrast better, or leading to a bright and high-definition image. At this time, the brightness of the peripheral area of the image is lowered to satisfy YP_{S3b}<YP_{S1b} as indicated by the characteristic curves 731b, 431b in FIG. 5B. This brightness difference does not make the humans feel uncomfortable through the eyes.

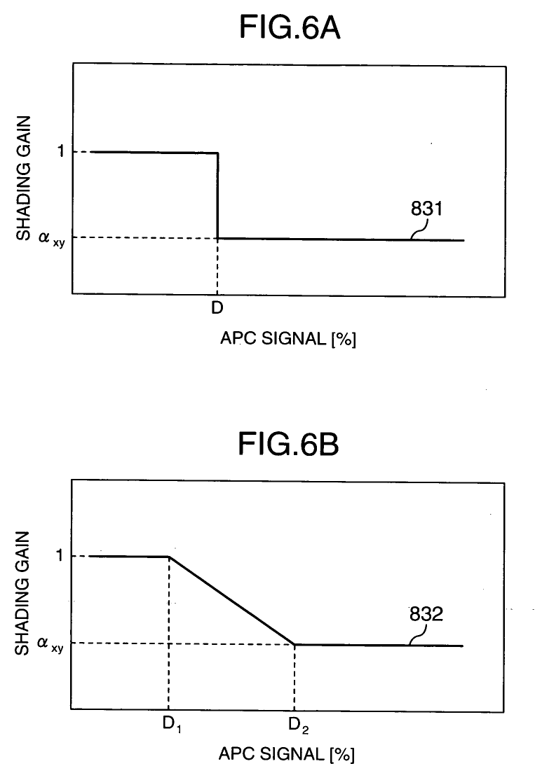

If we think of this operation from the luminescent energy point of view, the energy saved by lowering the brightness of the peripheral area is added to the brightness of the central area where it can more effectively contribute to the display quality. The brightness of the peripheral area is lowered by skillfully processing the input video signal, but the brightness of the central area is automatically increased by the conventional APC technology. The characteristic of the shading gain α according to the first embodiment will be described with reference to FIG. 6A.

In FIG. 6A, the abscissa is the APC signal, and the ordinate is the shading gain α. The characteristic, 831 of the shading gain α according to the first embodiment gives the shading gain α=1 when the APC signal S_{apc} is lower than a value D corresponding to the APL value, A of video signal S3 (at which the APC function becomes active). In other words, the region of APC signal S_{apc} smaller than the value D corresponds to the region below the APL value, A shown in FIG. 5A and FIG. 5B. Since the shading gain α=1 is given in this area, the video processor 521 does not make the peripheral-area brightness-reducing process.

When the APC signal S_{apc} is larger than value D, the shading gain α of the characteristic 831 takes the value α_{xy} corresponding to the coordinates (x, y) as, for example, expressed by the expression (1). That is, when the APC signal S_{apc} is larger than the value D to correspond to the region above the APL value, A in FIGS. 5A and 5B, the video processor 521 makes the peripheral-area brightness-reducing process. The APC is operated to increase the brightness of the central area so that the bright-room contrast can be improved with the power consumption maintained constant.

Thus, according to this embodiment of the video display apparatus, the brightness modulation processing operation of the video processor 521 is controlled according to the power consumption of the display panel. Therefore, in the high APL region where the APC function is actuated, the video image with better bright-room contrast and high-definition can be displayed without increasing the power consumption, and even in the low APL region where the APC function is not active, the picture quality can be kept high.

As in the above description, judgment is made of whether the peripheral-area brightness-reducing process is made or not by detecting whether the APC signal S_{apc} exceeds the threshold. However, the present invention is not limited to this judgment level, but may use another judgment level on the basis of which judgment is made of whether the peripheral-area brightness-reducing process is made or not, or may use a slightly smaller value than the threshold of APC signal S_{apc} where the APC function becomes active. This cannot inhibit the effect of this invention.

### Embodiment 2

The second embodiment will be described. FIG. 6B shows the characteristic of shading gain α according to the second embodiment.

The shading gain α of characteristic 831 according to the first embodiment as shown in FIG. 6A suddenly transits (changes) from 1 to α_{xy} or from α_{xy} to 1 at the boundary of the value D of APC signal S_{apc}. If, now, the APL value of video signal S3 varies around A, the APC signal S_{apc} also varies around the value D, and thus the shading gain α varies between 1 and α_{xy}. Therefore, the presence and absence of the peripheral-area brightness reduction frequently occur, and the brightness fluctuation due to this occurrence is easy to be perceived by the viewing audience. Thus, there is fear that the image characteristics are greatly deteriorated.

The second embodiment is to reduce this deterioration. The shading gain characteristic 831 is changed to have a decreasing curve with a gentle slope between the two points of shading gain 1 and the shading value α_{x,y} corresponding to the coordinates (x, y). This decreasing curve is effectively used to reduce the above brightness fluctuation so that the viewing audience cannot easily perceive the fluctuation.

In FIG. 6B, the abscissa is the APC signal, and the ordinate is the shading gain α. The characteristic 832 of shading gain α according to the second embodiment has shading gain α=1 when the APC signal S_{apc} is lower than a value D₁ corresponding to the APL value, A (the APL of video signal S3 where the APC function becomes active). When the APC signal is in the region between the values D₁ and D₂ (D₁<D₂), the shading gain is given by the decreasing curve that has a gentle slope and that connects 1 and the value α_{xy} corresponding to the coordinates (x, y) as, for example, expressed by the expression (1). When the APC signal is higher than the value D₂, the shading gain takes the value α_{xy} corresponding to the coordinates (x, y).

Under this characteristic curve 832, even if the APL value of the video signal S3 varies around A (that is, even if the APC signal S_{apc} varies around the value D1), the shading gain α is not suddenly changed. Therefore, the viewing audience does not perceive the brightness fluctuation since there is no sudden change of shading gain α.

The above method can be easily implemented by previously storing in the data memory 523 shown in FIG. 3 a shading gain pattern corresponding to a plurality of levels, and using any one of them selected according to the APC signal S_{apc}. The flowchart for the process in the CPU according to this embodiment can be obtained by slightly altering the flowchart shown in FIG. 1, and thus will not be described.

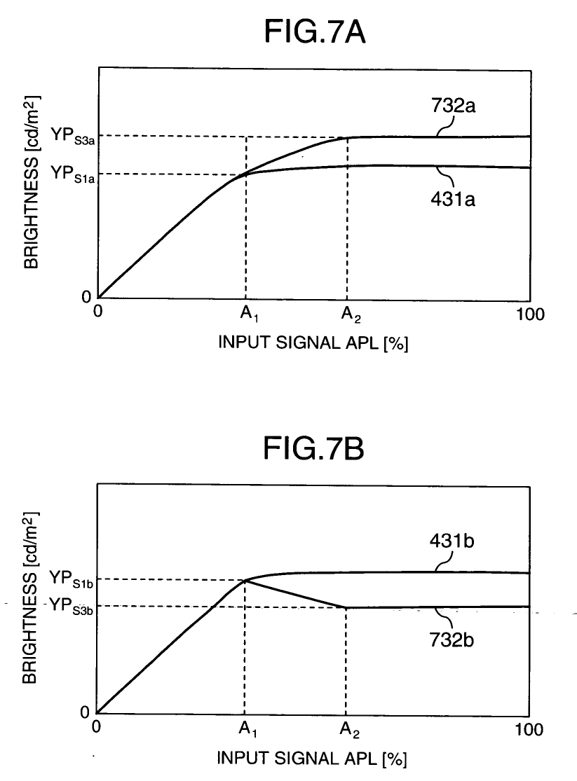

FIGS. 7A and 7B show the input video signal APL vs. brightness characteristics corresponding to the shading gain characteristic 832 shown in FIG. 6B. FIG. 7A shows that of the central area of the image, and FIG. 7B shows that of the peripheral area of the image. In FIGS. 7A and 7B, subscript a is attached to the central area brightness, and subscript b to the peripheral area brightness. The characteristic curves 431a, 431b indicate the brightness characteristics in the prior art, and the characteristic curves 732a, 732b the brightness characteristics according to this embodiment. In addition, the APL value of video signal S3 where the APC function is actuated is designated by A₁. This APL value A₁ corresponds to the value D₁ of the APC signal S_{apc} shown in FIG. 6B, and the APL value, A₂ corresponds to the value D₂ of the APC signal S_{apc} shown in FIG. 6B.

Referring to FIGS. 7A and 7B, when the APL value of video signal S3 is smaller than A₁, or when the APC signal S_{apc} is lower than the threshold, the video processor 521 does not make the peripheral-area brightness-reducing process as in the first embodiment. Therefore, the characteristic curves 732a, 732b of the peripheral and central areas are the same as the characteristic curves 431a, 431b. In other words, there is no brightness difference between the peripheral area and central area of the image, and thus the quality of the displayed image in the low APL region about which difficulties were left in the prior art is not deteriorated.

When the APL value of video signal S3 is larger than A₁ but smaller than A₂, or when the APC signal S_{apc} associated therewith is larger than D₁, but smaller than D₂, the video processor 521 makes the peripheral-area brightness-reducing process. At this time, the shading gain α that the multiplication circuit 521₂ of the video processor 521 uses to reduce the brightness is any value on the decreasing curve that connects 1 and the value α_{xy} corresponding to the coordinates (x, y) and that has a gentle slope as shown in FIG. 6B. Therefore, the brightness of the peripheral area of the image, as illustrated in FIG. 7B by the characteristic curve 732b, is smaller to satisfy YP_{S3b}<YP_{S1b} as compared to the characteristic curve 431b where the video signal S1 is supplied as it is (that is, the peripheral-area brightness-reducing process is not made). However, since the brightness YP takes any value on the curve connecting the brightness YP_{S1b} and the brightness YP_{S3b}, it gently changes differently from the characteristic curve 731b shown in FIG. 5B according to the first embodiment.

When the APL level of video signal S3 is larger than A₂, or when the APC signal S_{apc} is larger than the value D₂, the brightness of the central area is substantially equal to the brightness YP_{S3b}.

When the video processor 521 makes the peripheral-area brightness-reducing process, the power consumption is reduced since the brightness of the peripheral area is lowered. Accordingly, since the brightness of the central area can be increased by the amount corresponding to the reduction of power caused by the peripheral-area brightness-reducing process as in the first embodiment, the level of the limiter in the display/drive-control circuit 322 can be raised (that is, the number of discharge-maintaining pulses, for instance, can be increased) with the power consumption kept constant. Thus, the bright-room contrast can be improved.

However, this embodiment is different from the first embodiment. When the APL value of video signal S3 is between A₁ and A₂, the peripheral-area brightness-reducing rate is smooth, and thus the amount of power by which the brightness of the central area can be increased is also smoothly increased. Therefore, the brightness of the central area is smoothly increased like the characteristic curve 732a.

According to this embodiment, as mentioned above, the shading gain is not suddenly changed even if the APL value of video signal S3 is fluctuated around the APL value A₁. Thus, the viewing audience does not easily perceive the brightness fluctuation.

While the value D₁ of APC signal S_{apc} is selected as the threshold where the APC function is actuated in this embodiment, the invention is not limited to this threshold, but may of course use a slightly smaller threshold than the above threshold. However, D₂ is obviously larger than the above threshold. In other words, the above threshold may be fixed between D₁ and D₂.

In addition, while a decreasing curve with a gentle slope is used to connect the shading gain α=1 and the value α_{xy} corresponding to the coordinates (x, y) as shown in FIG. 6B, the invention is not limited to this curve. For example, this interval may be naturally divided into a plurality of sections, each of which is connected by a decreasing curve with a gentle slope.

In this embodiment, even if the APL value of video signal S3 varies around the APL value where the APC function becomes active, the amount of the brightness fluctuation is reduced so that the viewing audience cannot perceive the brightness variation. As another embodiment, the shading gain characteristic may have, for example, a hysteresis characteristic in the transition between the shading gain 1 and the shading gain α_{xy} corresponding to the coordinates (x, y) so that the brightness fluctuation cannot be caused.

### Embodiment 3

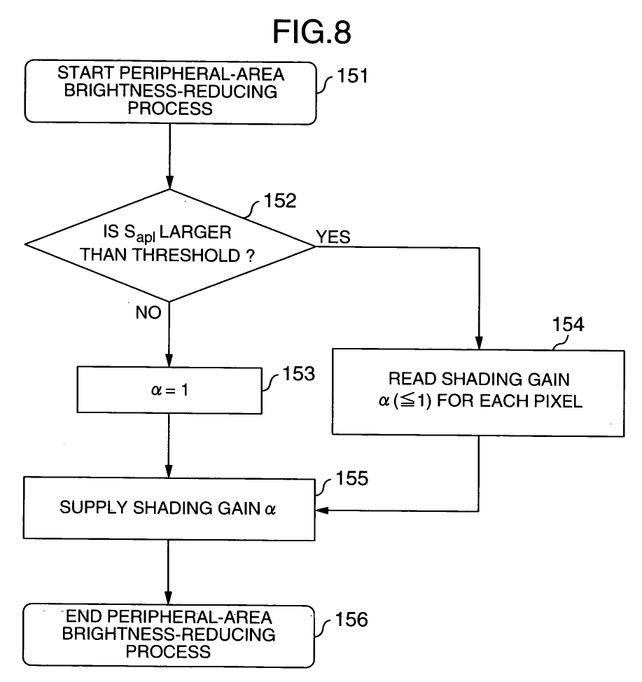

The third embodiment of the invention will be described with reference to FIGS. 8 and 9. In this embodiment, even if the APC signal S_{apc} cannot be fed back from the APC circuit 324 to the CPU 522 because of its construction as in the first embodiment, the peripheral-area brightness-reducing process can be controlled according to the displayed image.

FIG. 9 is a block diagram of a PDP type display apparatus of the third embodiment. The display/drive-control circuit 322, PDP 323, APC circuit 324, power circuit 325, video processor 521, CPU 522, and data memory 523 shown in FIG. 9 are the circuits and display panel having the same functions as in FIG. 3. In addition, the APL detection circuit, 1021 detects the APL of the video signal S1.

In this construction, the video signal S1 is supplied to the video processor 521, and also to the APL detection circuit 1021. The APL detection circuit 1021 detects the APL of the input video signal S1 and supplies this APL value Sₐₚ₁ to the CPU 522. The CPU 522 reads out the shading gain α according to this APL value Sₐₚ₁ from the data memory 523, and supplies it to the video processor 521. The subsequent process is the same as mentioned with reference to FIG. 3 in the first embodiment 1, and thus will not be described.

FIG. 8 is a flowchart for the process that is made by the CPU 522 in accordance with this embodiment. Referring to FIG. 8, immediately after the APL value Sₐₚ₁ is supplied from the APL detection circuit 1021 to the CPU 522, the CPU 522 starts the peripheral-area brightness-reducing process (step 151). Then, in step 152, it checks to see if this APL value Sₐₚ₁ is larger than a predetermined threshold. In other words, if the APL value Sₐₚ₁ is larger than the predetermined threshold in step 152, it reads out the shading gain α for each pixel from the data memory 523 in step 154, and supplies the shading gain α to the video processor 521 in step 155. If the APL value Sₐₚ₁ is smaller than the threshold, shading gain α=1 is selected in step 153 and supplied it to the video processor 521 in step 155. This processing operation is performed for each frame of the input video signal as in the first embodiment 1, and the peripheral-area brightness-reducing process is finished in step 156.

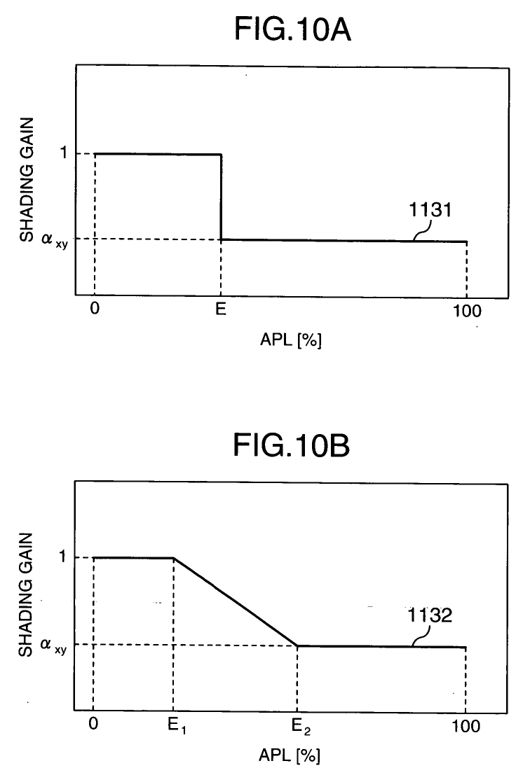

To control the brightness modulating process, a plurality of methods can be considered in the same way as, for example, shown in FIGS. 6A and 6B. In this embodiment, thresholds E, E₁ and E₂ as, for example, shown in FIG. 10 are used as the threshold for executing the brightness modulating process. These thresholds are determined by considering the following items. That is, in this embodiment, the video processor 521 multiplies the input video signal S1 by the shading gain α to produce the video signal S3 with the brightness of the peripheral area being reduced, and then supplies it to the display/drive-control circuit 322. However, when the brightness of the peripheral area is reduced, the APL of the video signal is also lowered, resulting in the condition of APL_{S1}>APL_{S3}. Here, the APL_{S3} is sometimes lowered than the value where the APC function becomes active. In this case, the brightness of the peripheral area is lowered, but the APC function is not actuated, and thus the brightness of the central area is not increased. When the threshold for the control is determined, it is necessary not to cause this situation. If the threshold for the APC function is, for example, 40% of the APL, it is preferable to select, for example, E=45% or 50% in the case of FIG. 10A, and for example, E₁=41%, E₂=50% in the case of FIG. 10B as the predetermined threshold where judgment is made of whether the brightness modulating process is performed.

In addition, if a timer circuit (not shown) or a counter circuit (not shown), although not included in this embodiment, is added to the construction shown in FIG. 3 or FIG. 9 so as to supply its output to the CPU 522, the shading gain can be controlled to change with time. It can also be considered that, by use of such control, the shading process is made, for example, only when the same image continues for a certain time.

As described above, the present invention controls the operation of the brightness modulating process for reducing the brightness of the peripheral area of the image in accordance with the power consumption of the display panel. Therefore, when the video signal is in the high APL region where the APC function is operated, a better bright-room contrast and high-definition image can be displayed without increasing the power consumption. Moreover, even when the video signal is in the low APL region where the APC function is not operated, the image can be displayed with its quality not so deteriorated. While the PDP according to the above embodiments has been described as an example of the self-luminous type display panel, the present invention can also be similarly applied to FED, EL and LED as described previously. In addition, the present invention can be similarly applied to LCD that is not a self-luminous display.

It should be further understood by those skilled in the art that although the foregoing description has been made on embodiments of the invention, the invention is not limited thereto and various changes and modifications may be made without departing from the spirit of the invention and the scope of the appended claims.

1. A video display apparatus comprising:
a display panel for displaying an image in accordance with an input video signal;
a brightness modulating circuit for reducing the brightness of said image on a peripheral area of said display panel as compared to that on a central area of said display panel; and
a control circuit for controlling said brightness modulating circuit in accordance with information about the operation of said display panel.

2. A video display apparatus comprising:
a display panel for displaying an image in accordance with an input video signal;
a brightness modulating circuit for reducing the brightness of said image on a peripheral area of said display panel as compared to that on a central area of said display panel;
a detection circuit for detecting an average power level of said input video signal; and
a control circuit for controlling the operation of said brightness modulating circuit on the basis of said average power level detected by said detection circuit.

3. A video display apparatus according to claim 2, wherein said control circuit judges whether said average power level detected by said detection circuit exceeds a predetermined threshold, and makes said brightness modulating circuit active if said detected average power level exceeds said predetermined threshold or inactive if said detected average power level is smaller than said predetermined threshold.

4. A video display apparatus according to claim 3, wherein said detection circuit detects the average power level per field or per frame of said input video signal as said average power level.

5. A video display apparatus comprising:
a display panel for displaying an image in accordance with an input video signal;
a brightness modulating circuit for reducing the brightness of said image on a peripheral area of said display panel as compared to that on a central area of said display panel;
a detection circuit for detecting a power consumption of said display panel; and
a control circuit for controlling the operation of said brightness modulating circuit in accordance with said power consumption detected by said detection circuit.

6. A video display apparatus according to claim 5, wherein said control circuit judges whether said power consumption detected by said detection circuit exceeds a predetermined threshold, and makes said brightness modulating circuit active if said detected power consumption exceeds said predetermined threshold or inactive if said detected power consumption is smaller than said predetermined threshold.

7. A video display apparatus according to claim 5, wherein said detection circuit detects said power consumption of said display panel by using a load current flowing in said display panel.

8. A video display apparatus comprising:
a display panel for displaying an image in accordance with an input video signal;
a brightness modulating circuit for reducing the brightness of said image on a peripheral area of said display panel as compared to that on a central area of said display panel;
an automatic output control circuit for limiting the power consumption of said display panel to a predetermined value or below; and
a control circuit for making said brightness modulating circuit be actuated in a load region where said automatic output control circuit operates or be stopped in a load region where said automatic output control circuit does not operate.

9. A video display apparatus according to claim 8, wherein said display panel is a self-luminous type plasma display panel.

10. A video display apparatus according to claim 8, wherein said brightness modulating circuit linearly reduces the brightness of the image displayed on said display panel more as the process proceeds from the central area to peripheral area of the image.

11. A video display apparatus according to claim 8, wherein said brightness modulating circuit modulates said input video signal so as to linearly reduce the brightness of the image displayed on said display panel more as the process proceeds from the central area to peripheral area of the image.

12. A video display apparatus according to claim 10, wherein the range from the central area to peripheral area of said image over which said brightness modulating circuit linearly reduces the brightness of said image is further divided into an interval from said center of said display panel to a predetermined point between said center and the outer edge of said image, where the brightness is reduced at a first reduction rate, and the other interval from said predetermined point to said outer edge, where the brightness is reduced at a second reduction rate different from said first reduction rate.

13. A video display apparatus according to claim 12, wherein said second reduction rate is larger than said first reduction rate.

14. A video display apparatus according to claim 8, further comprising, a lapsed-time counter for counting the lapsed time in which a predetermined image is displayed, and wherein said control circuit controls said brightness modulating circuit in accordance with said lapsed time counted by said counter.

15. A video display apparatus according to claim 8, wherein the operation of said brightness modulating circuit is switched on and off in accordance with the frequency band of a received video signal.
